(19) United States
(12) Patent Application Publication
(10) Pub. No.: US 2018/0268403 A1
(43) Pub. Date: Sep. 20, 2018

(54) MULTIPLE PROTOCOL TRANSACTION ENCRYPTION

(71) Applicant: Abhishek Guglani, (US)

(72) Inventor: Abhishek Guglani, (US)

(21) Appl. No.: 15/539,875

(22) PCT Filed: Jan. 27, 2016
(86) PCT No.: PCT/US2016/015158

§ 371 Date: Jun. 26, 2017

Related U.S. Application Data
(60) Provisional application No. 62/108,441, filed on Jan. 27, 2015.

(51) Int. Cl. G06Q 20/38; G06Q 20/36; H04W 4/80; H04L 9/32

(52) U.S. Cl. CPC G06Q 20/38215; G06Q 20/3829; H04L 2209/56; H04W 4/80; H04L 9/32; G06Q 20/3674

(57) ABSTRACT

Embodiments of the invention are directed to systems, apparatus, and methods for multiple protocol transaction encryption. In one embodiment, a mobile device can initiate a transaction in accordance with a first transaction protocol, the first transaction protocol being associated with contactless unidirectional communication. The mobile device can receive transaction data for the transaction in accordance with a second transaction protocol, the transaction data being received from an access device. The mobile device can perform further processing using the received transaction data. In some embodiments, the mobile device may generate a cryptogram from one or more data included in the transaction data. The cryptogram may be provided to the access device via the first transaction protocol.

### CROSS-REFERENCES TO RELATED APPLICATIONS

This application is a non-provisional of and claims the benefit of U.S. Provisional Application No. 62/108,441, filed Jan. 27, 2015, which is herein incorporated by reference in its entirety for all purposes.

### BACKGROUND

Mobile devices such as smart phones can use barcodes to conduct transactions. In such cases, access data such as an account number may be embedded in a barcode and the barcode may be read by an access device, which can grant access to a resource such as a good or service. Because the transmission of data using a barcode is essentially unidirectional or one way, transactions conducted using barcodes have limited security. For example, in the above scenario, if is possible for an unauthorized person to simply take a picture of the barcode and possibly reuse it in another transaction.

Embodiments of the invention address this and other problems, individually and collectively.

### BRIEF SUMMARY

Embodiments of the invention are directed to systems, apparatus, and methods for multiple protocol transaction encryption.

One embodiment of the invention is directed to a method. The method may comprise generating a unique code associated with a transaction upon receiving an indication that a transaction is to be completed. The method may also comprise providing information related to the transaction that includes a unique code to a mobile device via a first transaction protocol. The method may also comprise receiving a response message from the mobile device via a second transaction protocol different from the first transaction protocol. In response to determining that the mobile device received the unique code, the method may comprise completing the transaction using information included in the response message.

Another embodiment of the invention is directed to a method. The method may comprise initiating, by a mobile device, a transaction in accordance with a first transaction protocol, the first transaction protocol being associated with contactless unidirectional communication. The mobile device can receive transaction data for the transaction in accordance with a second transaction protocol, the transaction data being received from an access device. The mobile device can perform further processing using the received transaction data.

Another embodiment of the invention is directed to a mobile device that may comprise a processor and a computer-readable medium coupled to the processor. The computer-readable medium may comprise code executable by the processor for performing a method. The method may comprise initiating, by the mobile device, a transaction in accordance with a first transaction protocol, the first transaction protocol being associated with contactless unidirectional communication. The mobile device can receive transaction data for the transaction in accordance with a second transaction protocol, the transaction data being received from an access device. The mobile device can perform further processing using the received transaction data.

These and other embodiments of the invention are described in further detail below.

### BRIEF DESCRIPTION OF THE DRAWINGS

FIG. 1 illustrates a block diagram of an exemplary payment processing system in accordance with some embodiments;

FIG. 2 illustrates a block diagram of an exemplary mobile device in accordance with some embodiments;

FIG. 3 illustrates a block diagram of an exemplary access device in accordance with some embodiments;

FIG. 4 shows a flowchart illustrating an exemplary method of multiple protocol transaction encryption in accordance with some embodiments;

FIG. 5 illustrates a block diagram of an exemplary system and corresponding workflow for multiple protocol transaction encryption in accordance with some embodiments;

FIG. 6 shows a illustrative example data process flow in accordance with at least some embodiments;

FIG. 7 depicts a process for conducting a secured transaction using multiple protocols in accordance with at least some embodiments;

FIG. 8 depicts a process for receiving a transaction request via a first protocol and responding via a second protocol in accordance with at least some embodiments; and

FIG. 9 depicts an illustrative example of an embodiment in which a mobile device may be used to gain access to a building in accordance with at least some embodiments.

### DETAILED DESCRIPTION

Prior to discussing embodiments of the invention, a further description of some terms may be helpful in understanding embodiments of the invention.

A “mobile device” may include a device that can be portable. In some embodiments, a mobile device may be an electronic device that may be transported and operated by a user, which may also provide remote communication capabilities to a network and/or other electronic device. Examples of remote communication capabilities include using a mobile phone (e.g., wireless) network, wireless data network (e.g., 3G, 4G or similar networks), WiFi, WiMax, Bluetooth, radio frequency (RF) communication (e.g., NFC), or any other communication medium or protocol that may provide access to a network (e.g., the Internet or a private network) and/or facilitate communication with another electronic device. Examples of mobile devices include mobile phones (e.g., cellular phones), PDAs, tablet, computers, net books, laptop computers, personal music players, hand-held specialized readers, smart watches, fitness bands, ankle bracelets, earrings, automobiles with remove communication capabilities, and the like.

An “access device” may include any suitable device that may grant access to something (e.g., a resource). In some embodiments, an access device may be an electronic device that can be used to receive and/or retrieve information from a payment device in the context of an electronic payment transaction. Exemplary access devices include point of sale (POS) terminals, cellular phones, PDAs, desktop computers, laptop computers, tablet computers, handheld specialized readers, and the like. An access device may use any suitable contact or contactless mode of operation to send or receive date from, or associated with, a payment device such as a mobile device, credit card, debit card, and the like. In some embodiments, where an access device may comprise a POS terminal, any suitable POS terminal may be used and may include a reader, a processor, and a computer-readable medium. Exemplary readers can include radio frequency (RF) antennas, optical scanners, fear code readers, two-dimensional bar code (e.g., QR code) readers, and/or magnetic stripe readers to interact with a payment device.

An “account identifier” may be any indicator capable of identifying an account. For example, an account identifier may be a credit card number or a bank account number that may be used to make a payment or complete a transaction. In some embodiments, an account identifier may be a token or other representation of a payment account.

A “contactless unidirectional communication” may include an electronic communication protocol where information is transmitted or otherwise provided by one electronic device to another electronic device, but not vice versa. For example, in some embodiments, a contactless unidirectional communication can be associated with a two-dimensional barcode transaction protocol where a mobile device generates and displays a two-dimensional barcode that is read by a two-dimensional bar code reader of an access device.

A “cryptogram” may include a ciphered message. In some embodiments, a cryptogram cars include be used to authenticate an entity such as a device (e.g., a mobile device) or a user. For example, a cryptogram may comprise static (i.e., predetermined) data, dynamic data, or a combination of the two that is encrypted using an encryption key and an encryption algorithm (e.g., DES, triple DES, AES, etc.). In some embodiments, the cryptogram may comprise an account identifier that has been encrypted using an encryption key. In some embodiments of the invention, the encryption key may be a unique derived key (UDK) that is derived using an account information (e.g., an account number, expiration date, etc.) of a user. UDKs are useful, because they can be derived by encryption and decryption endpoints, and it is not strictly necessary to transport such keys. In some cases, the cryptogram may be decrypted to gain access to the account identifier. A cryptogram may be used in any suitable context. For example, a cryptogram may be used to confirm the registration of an entity, or to authenticate an entity conducting a transaction.

An “unique code” may include any set of data that is unique. In some embodiments, a unique code may include a number (including an unpredictable number), string, bit sequence, or other data value intended to be used in association with a single communication session (e.g., a single electronic transaction communication session). In some cases, a unique code may be randomly or pseudo-randomly generated. Typically, a unique code is of sufficient length as to make insignificant the likelihood of independently generating the same unique code multiple times.

An “authorization request message” may include an electronic message that request authorization. In some embodiments, an authorization request message requests authorization for a payment transaction. It can be sent to a payment processing network and/or an issuer of a payment account to request authorization for a transaction. An authorization request message according to some embodiments may comply with ISO 8583, which is a standard for systems that exchange electronic transaction information associated with a payment made by a user using a mobile device or payment account. The authorization request message may include an issuer account identifier (e.g., a PAN) that may be associated With a user mobile device or payment account or it may include a payment token (i.e., a PAN substitute). An authorization request message may also comprise additional data elements corresponding to identification information including, by way of example only: a service code, a CVV/iCVV (card verification value), a dCVV (dynamic card verification value), a cryptogram (e.g., a unique cryptographic value for the transaction), an expiration date, etc. An authorization request message may also comprise transaction information, such as any information associated with a current transaction, such as the transaction amount, merchant identifier (e.g., MVV), merchant location, merchant category code, etc., as well as any other information that may be utilized in determining whether to authorize a transaction.

An “authorization response message” may include an electronic message reply to an authorization request message. In some cases, the authorization response message may be generated by an issuing financial institution or a payment processing network. An authorization response message according to some embodiments may comply with ISO 8583. An authorization response message may include, by way of example only, one or more of the following status indicators: Approval—transaction was approved; Decline—transaction was not approved; or Call Center—response pending more information, merchant must call the toll-free authorization phone number The authorization may also include “identification information” as described below. The authorization response message may also include an authorization code, which may be a code that a credit card issuing bank returns in response to an authorization request message in an electronic message (either directly or through the payment processing network) to the merchant's access device (e.g., POS equipment) that indicates approval of the transaction. The code may serve as proof of authorization.

An “electronic wallet” or “digital wallet” can store user profile information, payment information, bank account information, and/or the like and can be used in a variety of transactions, such as but not limited to eCommerce, social networks, money transfer/personal payments, mobile commerce, proximity payments, gaming, and/or the like for retail purchases, digital goods purchases, utility payments, purchasing games or gaming credits from gaming websites, transferring funds between users, and/or the like. In some embodiments, a mobile device can utilize an electronic or digital wallet to conduct an electronic payment transaction.

A “machine readable code” may be any symbol, sign, or other visual representation of data configured to be interpreted by an electronic device. For example, a machine readable code may be a barcode. In some embodiments, a machine readable code may be linear, or one dimensional. In some embodiments, a machine readable code may be two-dimensional (e.g., a quick response (QR) code). A machine readable code may be scanned using an optical sensor of an electronic device and subsequently processed to retrieve data embedded in the machine readable code.

A “server computer” may include any suitable computer that can provide communications to other computers and receive communications from other computers. A server computer may include a computer or cluster of computers. For instance, a server computer can be a mainframe, a minicomputer cluster, or a group of servers functioning as a unit. In one example, a server computer may be a database server coupled to a Web server. A server computer may be coupled to a database and may include any hardware, software, other logic, or combination of the preceding for servicing the requests from one or more client computers.

A “processor” may include hardware within a mobile device (or other electronic device) that carries out instructions embodied as code in a computer-readable medium (e.g., a non-transitory computer-readable medium). An exemplary processor may be a central processing unit (CPU). As used herein, a processor can include a single-core processor, a plurality or single-core processors, a multi-core processor, a plurality of multi-core processors, or any other suitable combination of hardware configured to perform arithmetical, logical, and/or input/output operations of a computing device.

Embodiments of the invention are directed to systems, apparatus, and methods for multiple protocol transaction encryption. Although some of the examples below are described with respect to payments, embodiments of the invention are not limited to payments, but can be used in any situation where one seeks to gain access to a resource or location.

To illustrate, a user may conduct a transaction at a merchant using a mobile device (e.g., a cellular phone) configured to provide payment account information using a two-dimensional barcode (e.g., QR code) protocol. The merchant may enter transaction information (e.g., the transaction amount, items purchased, etc.) into the merchant's access device (e.g., a POS terminal) which may cause the access device to activate a two-dimensional barcode reader of the access device. Before or after the barcode reader is activated, the user can utilize a payment application (e.g., a mobile wallet application) on their mobile device to cause the mobile device to generate and display a two-dimensional barcode encoding the user's payment account information. The user can then initiate the transaction by positioning the mobile device display including the two-dimensional barcode into the field of view of the two-dimensional barcode reader of the merchant's access device.

Upon scanning the displayed two-dimensional barcode, the access device can generate an “unique code” for the transaction. This unique code can be transmitted by the access device to the user's mobile device using, for example, a near field communication (NFC) protocol. The mobile device can then use an encryption algorithm and an encryption key to generate a cryptogram using the unique code. The mobile device can then generate a new two-dimensional barcode for the transaction and can encode the cryptogram within this new barcode. The reader of the merchant's access device can scan the new two-dimensional barcode including the encoded cryptogram, and can generate an authorization request message for the transaction. The authorization request message can then be routed to the issuer of the account used to conduct the transaction via a payment processing network, and can include the cryptogram, the unique code, transaction amount, and any other suitable information usable to authorize and authenticate the transaction.

Authentication can be performed by the issuer and/or the payment processing network. For example, the authorization request message can be received by the payment processing network which may have access to the secure encryption algorithm. In some embodiments, using the unique code included in the authorization request message and the encryption algorithm, the payment processing network can generate a cryptogram. The cryptogram may then be compared to the cryptogram generated by the mobile device and included in the authorization request message. If the cryptograms match, this may indicate that the mobile device and/or the user are authenticated such that the transaction may proceed. In some embodiments, the received cryptogram may be decrypted. In some embodiments, the decrypted data may be compared to an expected value. In some embodiments, the decrypted data may comprise an account identifier.

Embodiments of the invention can provide a number of technical advantages. For transaction protocols associated with contactless unidirectional communication such as two-dimensional bar code transactions, no data usable for authentication purposes may be transmitted back to the mobile device from the access device. In embodiments of the invention, another transaction protocol can be used to supplement the unidirectional protocol to allow for authentication of the transaction. For example, an NFC communication can be used to provide a unique code which can be used by the mobile device to generate a cryptogram. As explained above in the context of a two-dimensional barcode transaction, the cryptogram can be encoded in a barcode and inserted into an authorization request message, thereby allowing a resource providing entity such as a payment processing network and/or account issuer to authenticate the transaction.

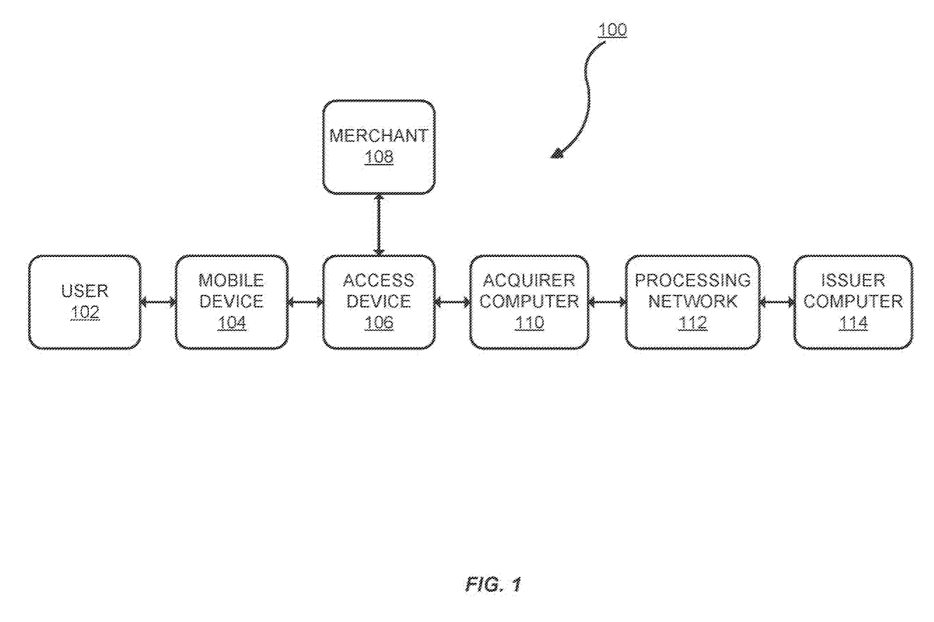

FIG. 1 illustrates a block diagram of an exemplary payment processing system 100 in accordance with some embodiments. Although some of the entities and components in system 100 are depicted as separate, in some instances, one or more of the components may be combined into a single device or location. Similarly, although certain functionality may be described as being performed by a single entity or component within system 100, the functionality may, in some instances, be performed by multiple components and/or entities. Communication between entitles and components may comprise the exchange of data or information using electronic messages and any suitable electronic communication medium and method, as described below. In accordance with at least some embodiments, the disclosure provides a technical advantage in that an access device 108 without a multidirectional communication device may be utilized to securely perform a transaction with a mobile device 104 using the disclosed techniques.

As illustrated in FIG. 1, system 100 may include one or more users, mobile devices, access devices, merchants, acquirer computers, payment processing networks, and issuers computers. For example, as illustrated in FIG. 1, system 100 can include a user 102 having a mobile device 104.

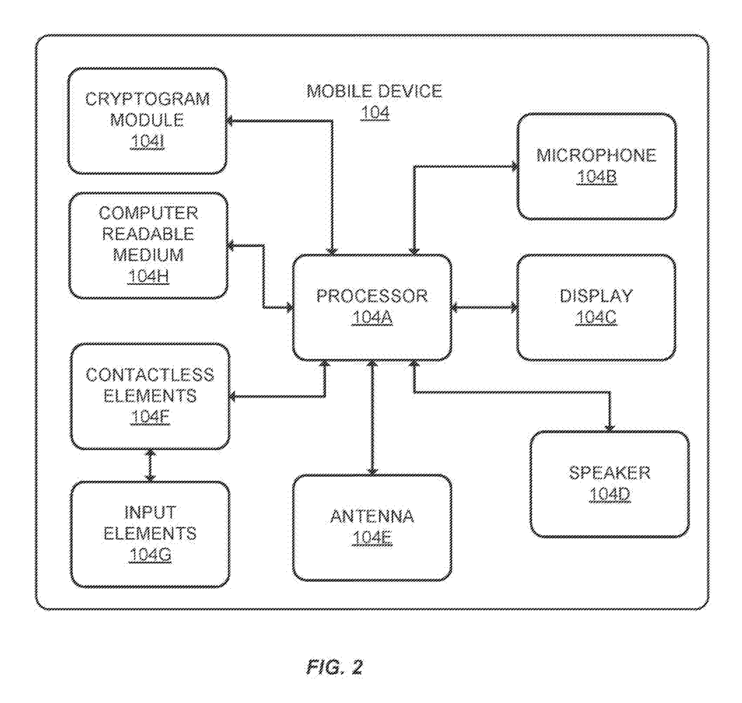

FIG. 2 illustrates a block diagram of exemplary mobile device 104 in accordance with some embodiments. As shown in FIG. 2, mobile device 200 may include a computer readable medium 104H that may be present within a body or outer casing of mobile device 104, or computer readable medium 104H could be detachable from mobile device 104 (e.g., an external memory that could be connected through a physical interface such as a USB connection, or the data could be hosted remotely and accessed wirelessly by the device—e.g., the data could be hosted and stored at a remoter server in the “cloud”). Computer readable medium 104H may be in the form of a memory that stores data. The memory may store information such as financial information, transit information (e.g., as in a subway or train pass), access information (e.g., access badges), serial numbers, mobile account information, and any other suitable information. In general, any of this information may be transmitted by mobile device 104 (such as to an access device as described below), via any suitable method, including the use of an antenna 104E or contactless element 104F. The body of mobile device 104 may be in the form a plastic substrate, housing, or other structure.

In some embodiments, mobile device 104 may further include contactless element 104F, which is typically implemented in the form of a semiconductor chip (or other data storage element) with an associated wireless transfer (e.g., data transmission) element, such as an antenna (e.g., antenna 104E). Contactless element 104F may be coupled to (e.g., embedded within) mobile device 104 and data or control instructions that are transmitted via a cellular network may be applied to contactless element 104F by means of a contactless element interface (not shown). The contactless element interface functions to permit the exchange of data and/or control instructions between the mobile device circuitry and contactless element 104F, or between another device having a contactless element (e.g., a POS terminal or a payment device). Contactless element 104F may be capable of transferring and receiving data using a short range wireless communication capability, for example, using NFC or other contactless mechanisms and protocols described above. Mobile device 104 may comprise components to both be the interrogator device (e.g., receiving data) and the interrogated device (e.g., sending data). Thus, mobile device 104 may be capable of communicating and transferring data or control instructions via both a cellular network (or any other suitable wireless network—e.g., the Internet or other data network) and short range or contactless communications.

Mobile device 104 may also include a processor 104A (e.g., a microprocessor) for processing the functions of mobile device 104 and a display 104C to allow a user, merchant, and/or other entity to see phone numbers, menus and other information and messages, such as a two-dimensional barcode and/or payment information. Mobile device 104 may further include input elements 104G to allow information to be inputted into the device, a speaker 104D to allow voice communication, music, etc. to be outputted, and a microphone 104B to allow audio such as voice commands and other audio input to be provided to mobile device 104.

In some embodiments, as shown in FIG. 2, mobile device 104 can further include a cryptogram module 104I. As described in further detail below, cryptogram module 104I can be configured to generate a cryptogram using transaction data such as a unique code received from a merchant's access device (e.g., via contactless elements 104F and/or antenna 104E. Cryptogram module 104I may be further configured to encode a generated cryptogram into a two-dimensional barcode that may be displayed, for example, using display 104C.

Returning to FIG. 1, system 100 can further include an access device 106 operated by a merchant 108. As used herein, a “merchant” may refer to an entity that engages in transactions and that can sell goods and/or services to users. In some embodiments, a merchant may be a “stationary merchant” that can sell goods and/or services at a fixed location. In some embodiments, a merchant can be a “mobile merchant” that can sell goods and/or services at different locations. Access device 106 may be in any suitable form. Exemplary access devices include, but are not limited to, point of sale (POS) terminals, mobile phones (e.g., smart phones), PDAs, desktop computers, laptop computers, net books, tablet computers, media players, handheld specialized readers, and the like. Access device 108 may use any suitable contact or contactless mode of operation to send or receive date from, or associated with, a payment device (e.g., mobile device 104). In some embodiments, where access device 106 comprises a POS terminal, any suitable POS terminal may be used and may include a reader, a processor, and a computer-readable medium. Exemplary readers can include radio frequency (RF) antennas, optical scanners, bar code readers, QR code readers, and/or magnetic stripe readers configured to interact with a payment device such as mobile device 104. Access device 106 can include an external communication interface such as a network interface for communicating with an acquirer computer 110 or other entity illustrated in FIG. 1, system memory comprising one or more modules to facilitate multiple protocol transaction description as described herein, and a data processor for facilitating financial transactions and the exchange of electronic messages.

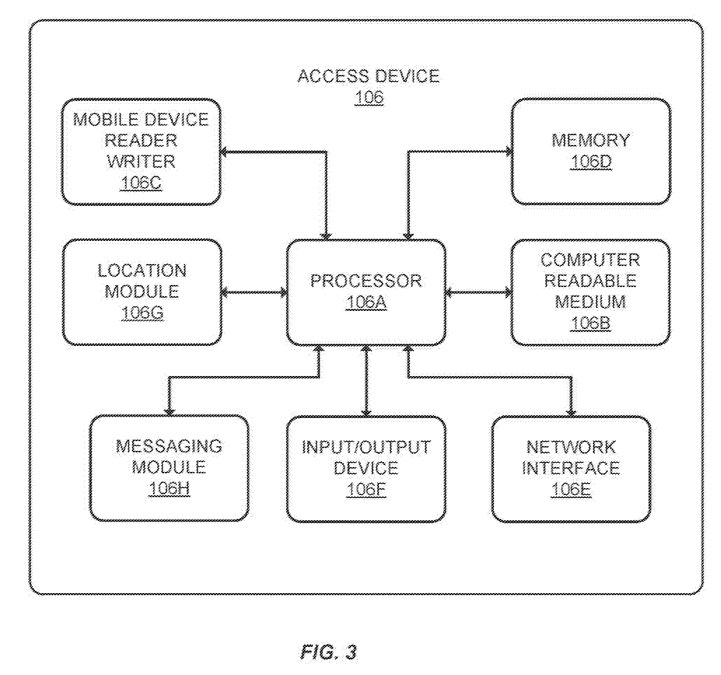

FIG. 3 illustrates a block diagram of exemplary access device 106 in accordance with some embodiments. As shown in FIG. 3, access device 106 may comprise a processor 106A. It may also comprise a computer readable medium 106B, a mobile device reader writer 106C, a memory 106D, a network interface 106E, an output device 106F, a location module 106G, and a messaging module 106H, all operatively coupled to processor 106A. A housing may house one or more of these components. Output device 106F may include a display and/or an audio output device such as one or more speakers. Computer readable medium 106B may include one or more memory chips, disk drives, etc. As described herein, access device 106 may be configured to communicate with a payment device (e.g., mobile device 104) by way of multiple transaction protocols. As such, mobile device reader writer 106C of access device 106 may include one or more radio frequency (RF) antennas, optical scanners, bar code readers, QR code readers, and/or magnetic stripe readers configured to interact with mobile device 104.

Messaging module 106H may be configured to generate authorization request messages and/or to receive authorization response messages. In some embodiments, authorization request messages generated by messaging module 106H may include unique codes generated by access device 106, cryptograms encoded in two-dimensional barcodes generated by mobile devices, in addition to other information used to authenticate and/or authorize a transaction. Network interface 106E may be configured to cooperate with messaging module 106H to facilitate the exchange of authorization messages with acquirers (e.g., via acquirer computer 110), issuers (e.g., via an issuer computer 114), payment processing networks (e.g., a payment processing network 112), and/or processors (e.g., issuer processors, acquirer processors, merchant processors, and the like).

In some embodiments, where access device 106 is a mobile access device for example, it can further include location module 106G. Location module 106G may include software and/or hardware for determining a current location of access device 106. For instance, location module 106G may utilize a Global Positioning System (GPS), cellular phone tower triangulation data, cellular phone tower signal strength data, wireless access point location data, an internet Protocol (IP) address, or any other suitable means for determining a geographic location of access device 106.

Returning to FIG. 1, system 100 may further include acquirer computer 110 operated by an acquirer. As used herein, an “acquirer” may refer to a business entity (e.g., a commercial bank or financial institution) that has a business relationship with a particular merchant or similar entity, and that facilitates clearing, settlement, and any other suitable aspect of electronic payment transactions. Acquirer computer 110 may include an external communication interface (e.g., for communicating with access device 106, payment processing network 112, or other entity), system memory comprising one or more modules to generate and utilize electronic messages, and a data processor for facilitating financial transactions and the exchange of electronic messages.

System 100 may further include issuer computer 114 operated by an issuer. As used herein, an “issuer” may refer to a business entity (e.g., a bank or other financial institution) that maintains financial accounts for users and that may issue payment accounts and user payment devices (e.g., credit cards, debit cards, and the like) used to access funds of such accounts. Some entities may perform both issuer and acquirer functions. Issuer computer 114 may include an external communication interface (e.g., for communicating with payment processing network 112 or other entity), system memory comprising one or more modules to generate and utilize electronic messages, and a data processor for facilitating financial transactions and the exchange of electronic messages.

System 100 may further include payment processing network 112, which may include data processing subsystems, networks, and operations used to support and deliver authorization services, exception file services, and clearing and settlement services. For instance, payment processing network 112 may comprise a server computer, coupled to a network interface (e.g., by an external communication interface), and a database(s) of information. An exemplary payment processing network may include VisaNet™. Payment processing networks such as VisaNet™ are able to process credit card transactions, debit card transactions, and other types of commercial transactions. VisaNet™, in particular, includes a VIP system (Visa Integrated Payments system) which processes authorization requests and a Base II system which performs clearing and settlement services. Payment processing network 112 may include an external communication interface (e.g., for communicating with acquirer computer 110, issuer computer 114, or other entity), system memory comprising one or more modules to generate and utilize electronic messages, and a data processor for facilitating financial transactions and the exchange of electronic messages.

Many of the data processing functions and features of some embodiments of the invention may be present in mobile device 104 and/or access device 106. It should be understood, however, that such functions and features could be present in other components of system 100.

Access device 106, acquirer computer 110, payment processing network 112, and issuer computer 114 may all be in operative communication with each other. For example, as described above, some or all of these components in system 100 can include an external communication interface. As used herein, an “external communication interface” may refer to any hardware and/or software that enables data to be transferred between two or more components of system 100 (e.g., between devices residing at locations such as an issuer, acquirer, merchant, payment processing network, etc.). Some examples of external communication interfaces may include a modem, a network interface (such as an Ethernet card), a communications port, a Personal Computer Memory Card International Association (PCMCIA) slot and card, and the like. Data transferred via an external communications interface may be in the form of signals which may be electrical, electromagnetic, optical, or any other signal capable of being received by the external communications interface (collectively referred to as “electronic signals” or “electronic messages”). These electronic messages that may comprise data or instructions may be provided between one or more of the external communications interface via a communications path or channel. As noted above, any suitable communication path or channel may be used such as, for instance, a wire or cable, fiber optics, a telephone line, a cellular link, a radio frequency (RF) link, a WAN or LAN network, the Internet, or any other suitable method.

As would be understood by one of ordinary skill in the art, any suitable communications protocol for storing, representing, and transmitting data between components of system 100 may be used. Some examples of such methods may include utilizing predefined and static fields (such as in core TCP/IP protocols); “Field: Value” pairs (e.g.; HTTP, HTTPS, FTP, SMTP, POP3, and SIP); an XML based format; and/or Tag-Length-Value format.

In some embodiments, the mobile device 104 can facilitate an “electronic” or “digital wallet” that may be used to conduct an electronic payment transaction. In such embodiments, an electronic wallet server (not shown) may be in operational communication with access device 106, payment processing network 112, and/or other entity, and may maintain an association between the user's digital wallet and one or more payment accounts (e.g., credit, debit, prepaid accounts, and the like). An electronic wallet server can provide a web interface (e.g., through one or more web pages) to receive and transmit requests for payment services and/or may provide an application program interface (API) on mobile device 104 to provide the web service.

A description of a typical electronic transaction flow using system 100 may be helpful in understanding embodiments of the invention. As an initial step, user 102 may attempt to purchase goods and/or services from merchant 108. In the context of a two-dimensional barcode transaction, this may involve user 102 using an application on mobile device 104 to cause a two-dimensional barcode to be generated and displayed. The barcode can encode information about a payment account used by user 102 to conduct the transaction. User 102 can place the displayed two-dimensional barcode in the field of view of a barcode reader of the merchant's access-device 106 which can extract or otherwise interpret the account information contained in the barcode.

Access device 106 may then generate an authorization request message for the transaction, and can transmit this message to acquirer computer 110 which can then route the authorization request message to payment processing network 112. Upon receipt, payment processing network 112 may perform various processing steps (e.g., fraud detection, standalone authorization, etc.), and may then forward the authorization request message to issuer computer 114 which may be operated by the issuer of the account for which information is encoded in the two-dimensional barcode displayed by mobile device 104.

Issuer computer 114 can perform a number of processes after receiving the authorization request message (e.g., verifying the account, confirming that the account has a sufficient balance or available credit to cover the amount of the transaction, user fraud defection, and/or other processes) to determine whether to authorize the transaction. After making an authorization decision, an authorization response message is generated by issuer computer 114 including an indication of the authorization decision, and is transmitted by issuer computer 114 to acquirer computer 110 via payment processing network 112. Acquirer computer 110 may store a record of the authorization decision and then forward the authorization response message to access device 106. Access device 106 may then provide an indication to user 102 and/or merchant 108 whether authorization of the transaction has been approved or declined by the issuer. In some embodiments, this may involve displaying an indication of the authorization decision on a display of access device 106.

In some embodiments, as described in further detail below, transactions involving unidirectional communication such as two-dimensional barcode protocols can be authenticated by way of multiple transaction protocols. For example, upon reading the two-dimensional barcode displayed by mobile device 104, access device 106 may generate transaction data that can be used for authentication. In some embodiments, this transaction data can include a unique code which is transmitted by access device 106 to mobile device 104 using a different protocol such as NFC. Upon receipt, mobile device 104 can generate a cryptogram using the unique code and an encryption algorithm and an encryption key. Mobile device 104 can then generate a new two-dimensional barcode including the encoded cryptogram. User 102 can then position the new displayed cryptogram into the field of view of the barcode reader of access device 106. In such embodiments, the authorization request message routed to issuer computer 114 can include the cryptogram and the unique code. Issuer computer 114, payment processing network 112, and/or acquirer computer 110 may also be in possession of (or otherwise have access to) the secure encryption algorithm. Upon receipt of the authorization request message including the cryptogram and unique code, the authenticating entity (e.g., issuer computer 114, payment processing network 112, and/or acquirer computer 110) can independently generate a cryptogram using the encryption algorithm and unique code, and can compare it with the cryptogram included in the authorization request message. If the cryptograms match (i.e. are identical in at least some respect), mobile device 104 and/or user 102 can be authenticated. In some embodiments, the access device, or another entity, may decrypt the cryptogram using a decryption algorithm related to the encryption algorithm used to generate it.

Upon completion, if the transaction was authorized and authenticated, a clearing and settlement process can be conducted. A clearing process may include the exchange of financial details between acquirer computer 110 and issuer computer 114 across payment processing network 112 to facilitate posting to the user's account and reconciliation of the settlement position. A settlement process may include the actual transfer of funds from issuer computer 114 to acquirer computer 110. In some embodiments, to initiate settlement, acquirer computer 110 can transmit a settlement file including an approval code for the transaction (along with other approved transactions in a batch format) to payment processing network 112 which can then communicate with issuer computer 114 to facilitate the transfer of funds.

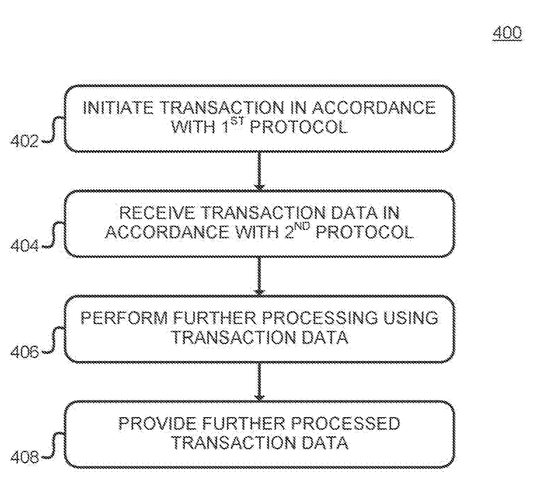

FIG. 4 shows a flowchart illustrating an exemplary method 400 of multiple protocol transaction encryption in accordance with some embodiments. The steps of method 400 may be performed, for example, by mobile device 104. In other embodiments, one or more steps of method 400 may be performed by any other suitable entity such as one or more of the entities of system 100 shown in FIG. 1. In some embodiments, one or more steps of method 400 may be performed by an entity not shown FIG. 1, such as a merchant processor, issuer processes, acquirer processor, or any other suitable entity.

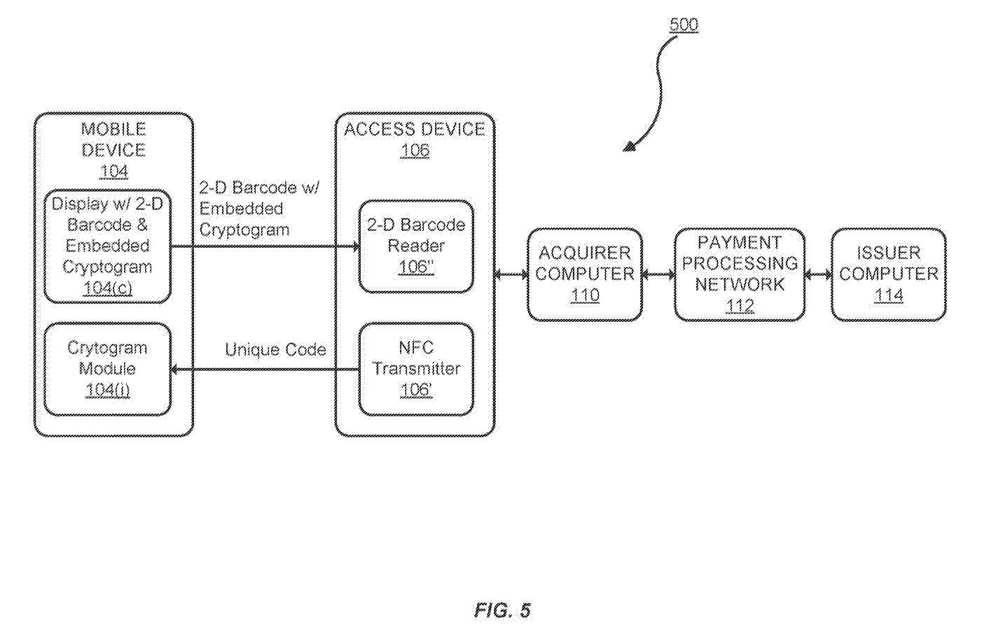

In the below description of method 400, a non-limiting illustration is provided with reference to FIG. 5 as well as the other Figures. FIG. 5 illustrates a block diagram of an exemplary system and corresponding workflow 500 for multiple protocol transaction encryption in accordance with some embodiments. As seen in FIG. 5, the system may include one or more components of system 100 shown in FIG. 1, such as mobile device 104, access device 106, acquirer computer 110, payment processing network 112, and issuer computer 114.

Returning to method 400 shown in FIG. 4, at step 402, a mobile device 104 can initiate a transaction in accordance with a first transaction protocol, the first transaction protocol being associated with contactless unidirectional communication. In some embodiments, the first transaction protocol associated with contactless unidirectional communication can be a two-dimensional barcode (e.g., QR code) transaction protocol.

As an illustration, with reference to workflow 500 shown in FIG. 5, step 402 can include user 102 interacting with an application on mobile device 104 that causes a two-dimensional barcode to be generated that encodes information about an account (e.g., primary account number, expiration date, CVV code, etc.) selected by user 102 for conducting the transaction with merchant 108. Mobile device 104 can display the two-dimensional barcode on display 104C, and user 102 can position the displayed two-dimensional barcode within the field of view of a two-dimensional barcode reader 106″ of access device 106.

At step 404 of method 400, the mobile device 104 can receive transaction data for the transaction in accordance with a second transaction protocol, the transaction data being received from an access device 106. In some embodiments, the transaction data received from the access device 106 in accordance with the second transaction protocol can include a unique code.

For example, in the illustration shown in FIG. 5, at step 404 an NFC transmitter 106′ of access device 106 can transmit a unique code to mobile device 104. In this illustration, the two-dimensional barcode protocol corresponds to the first transaction protocol and the NFC protocol corresponds to the second transaction protocol.

At step 406, the mobile device can perform further processing using the received transaction data. For example, the mobile device may generate a response using the received transaction data. In some embodiments, the further processing can include generating a cryptogram using the unique code. In some embodiments, the further processing further includes encoding the generated cryptogram in a two-dimensional barcode. At 408, the resulting processed data may be provided to another entity (e.g., the access device) via the first transaction protocol. For example, the mobile device may display the generated two dimensional barcode that includes the cryptogram so that if may be scanned.

Referring back to the above illustration with reference to workflow 500, at step 406, cryptogram module 104I of mobile device 104 can process the received unique code using an encryption algorithm and an encryption key to generate a cryptogram for the transaction. Mobile device 104 can then generate a new two-dimensional barcode in which the cryptogram is embedded. Two-dimensional barcode reader 106″ of access device 106 can then extract or otherwise obtain the encoded information including the cryptogram from the new barcode displayed on display 104C of mobile device 104.

As described above, access device 106 can then generate an authorization request message including information for authorization of the transaction (e.g., account information, transaction amount, etc.), the cryptogram, and the unique code. An authenticating entity such as payment processing network 112, issuer computer 114, and/or acquirer computer 110 can then independently generate the cryptogram upon receipt of the authorization request message using the unique code, a corresponding encryption key, and secure encryption algorithm. If the generated cryptogram matches the cryptogram received from mobile device 104 and included in the authorization request message, user 102 and/or mobile device 104 can be authenticated. In some embodiments, if authentication is successful, authorization can then be performed by issuer computer 114 and/or payment processing network 112. In some embodiments, authentication and authorization can be performed in parallel by different entities shown in FIGS. 1 and 5, or by the same entity.

In the illustration described above with reference to Workflow 500, mobile device 104 generates a two-dimensional barcode, receives a unique code, and then generates a new two-dimensional barcode encoding a cryptogram generated using the unique code. In such embodiments, these steps can be performed very rapidly (e.g., fractions of a second) such that user 102 only needs to position mobile device 104 in the field of view of two-dimensional bar code reader 106″ once and without having to maintain its position for an inconvenient length of time. It should be noted, however, that the description of such embodiments is not intended to be limiting. For example, in some embodiments, the transaction may be initiated by the unique code being transmitted by access device 106 to mobile device 104. In such embodiments, only one two-dimensional barcode (i.e. including the encoded cryptogram) may be generated.

Further, in the above illustration, access device 106 includes both two-dimensional barcode reader 106″ and NFC transmitter 106′. In some embodiments, these two components can be positioned adjacent to each other such that information can be exchanged with mobile device 104 without user 102 having to reposition mobile device 102 to communicate in accordance with the two protocols. In some embodiments, however, where two-dimensional barcode reader 106″ and NFC transmitter 106′ are positioned some distance away from each other, user 102 may need to reposition mobile device 104 to facilitate the multiple protocol transaction encryption processes described herein. For example, user 102 may place mobile device 104 in the vicinity of NFC transmitter 106′ to receive a unique code for a transaction, and may then reposition mobile device after generation of a cryptogram so that display 106C is in the field of view of two-dimensional barcode reader 106″.

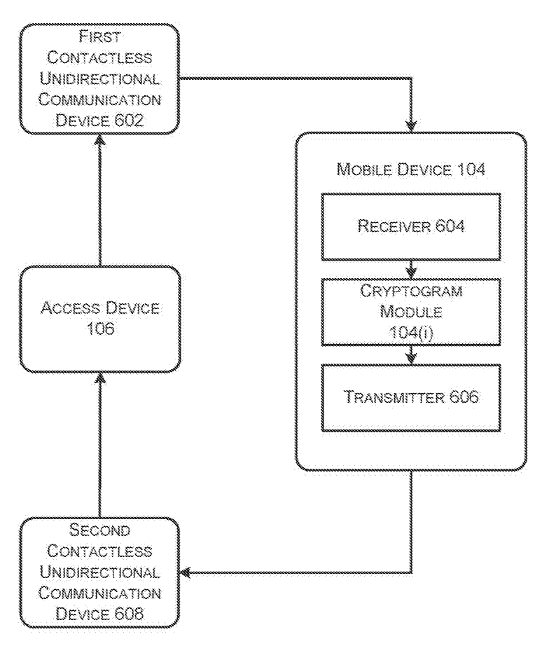

FIG. 6 shows a illustrative example data process flow in accordance with at least some embodiments. In FIG. 6, an access device 106 is depicted as being in communication with multiple contactless unidirectional communication devices. In particular, this example illustrates a scenario in which the access device uses two contactless unidirectional communication devices to conduct a transaction. Upon detecting that a transaction is to be conducted, the access device 106 may be provided with information related to the transaction as well as a unique code. In some embodiments, the access device may generate the unique code. For example, a random number generator may be used to generate a unique code. In some embodiments, the access device may be provided with the unique code by an acquirer computer or other suitable entity.

Once the access device 106 has been provided with the unique code, it may communicate the transaction information and unique code to a mobile device 104 via a first contactless unidirectional communication device 602. In some embodiments the first contactless unidirectional communication device 602 may be an NFC device. In some embodiments, the first contactless unidirectional communication device 602 may be display device capable of displaying a machine readable code (e.g., a barcode).

The transaction information and unique code may be received at the mobile device 104 by a receiver 604. The receiver may be any device capable of receiving a communication from the first contactless unidirectional communication device 602. For example, the receiver 604 may be an antenna device capable of receiving a near field communication. In another example, the receiver 604 may be a barcode reader capable of capturing a machine readable code displayed on a display of the access device. The receiver 604 receives transaction information and/or a unique code and provides that information to a cryptogram module 104I.

As described above, the cryptogram module 104I, working with the processor 104A may be configured to generate a cryptogram using the received information. The cryptogram module 104I, in conjunction with the processor 104A, may be further configured to generate a machine readable code or other response that includes the generated cryptogram. For example, the cryptogram module 104I, in conjunction with the processor 104A, may be configured to receive the unique code and transaction details from the access device 106 and provide payment account information to be utilized in the transaction. By way of further example, the response may include a barcode that includes the encrypted payment account identifier to be used in the transaction (an indication of a payment account to be utilized). In some embodiments, the response may include a merchant identifier, loyalty information (e.g., rewards or coupons), and/or an authorized payment amount based on the transaction information received from the access device. In some embodiments, the response may also include the unique code. In some embodiments, the response may be encrypted using the unique code. For example, the plaintext payment account identifier may be translated into a cryptogram (e.g., a ciphertext) using the provided unique code as the encryption key. In some embodiments, the unique code may be a symmetric key (e.g., an encryption key that may be used for both encryption and decryption). In some embodiments, the unique code may be a public key of an asymmetric keypair (e.g., a key that may be used to encrypt or decrypt data, but not both). This response may be transmitted, via a transmitter 606, to a second contactless unidirectional communication device 608.

In some embodiments, the response may be translated into a particular format. In some embodiments, the format to be applied to the response may be determined based on information received from the access device. For example, the mobile device 104 may receive an indication that the access device 106 is equipped with a barcode scanner as a second contactless unidirectional communication device 608. In this example, the response may be formatted into a barcode format, to be read by the second contactless unidirectional communication device 608. In some embodiments, the response may be translated into a predetermined format. Upon detection of the response, the access device 106 may identify the payment account identifier from the response.

By way of illustration, consider a scenario in which the access device is a merchant point of sale (POS) equipped with an NFC transmitter and a barcode scanner. In this example, upon a cashier indicating that the transaction is ready to be completed, the access device may communicate a unique code (e.g., an unpredictable number), as well as other transaction information to the mobile device via the NFC transmitter. The mobile device may then translate the payment account identifier into a cryptogram using the unique code as an encryption key and generate a barcode that includes the cryptogram. The generated barcode may be displayed on the screen of the mobile device. The barcode reader of the access device may then be utilized to scan the display of the mobile device in order to access the cryptogram. Once received, the access device 106 may decrypt the cryptogram back into plaintext in order to access the payment account identifier.

By way of a second illustration, consider a scenario in which the access device is a merchant point of sale (POS) equipped with a display and an NFC receiver. In this example, upon a cashier indicating that the transaction is ready to be completed, the access device may generate a machine readable code that includes information related to the transaction as well as a unique code (e.g., a random or otherwise unpredictable number). The mobile device may then identify the transaction information and unique code from the barcode. The mobile device may translate the payment account identifier into cryptogram using the unique code as an encryption key and generate a response that includes the cryptogram. The generated response may be transmitted to the access device 106 via the NFC receiver. Once received, the access device 106 may decrypt the cryptogram of the response back into plaintext in order to access the payment account identifier.

In accordance with at least some embodiments, at least one of the unidirectional communication protocols may be a long range wireless transmission means. For example, the unidirectional communication protocol may be a wireless local area network (e.g., Wi-Fi). In some embodiments, the long range wireless communication protocol may be used to set up a virtual perimeter (e.g., a geo-fence). A mobile device may be provided with a unique code via the unidirectional communication protocol upon entering a particular geographic area.

By way of illustrative example, consider a scenario in which a merchant retail store includes a wireless local area network. In this scenario, when a user with a mobile device enters the retail store, a unique code may be provided to the mobile device via the wireless local area network. Upon the user conducting a transaction using the mobile device, the mobile device may generate a cryptogram using the provided unique code. The cryptogram may be conveyed to a point of sale device of the merchant retailer via a barcode scanner communicatively coupled to the point of sale device. In some embodiments, each mobile device that enters the vicinity of the merchant retail store may be provided with a different unique code.

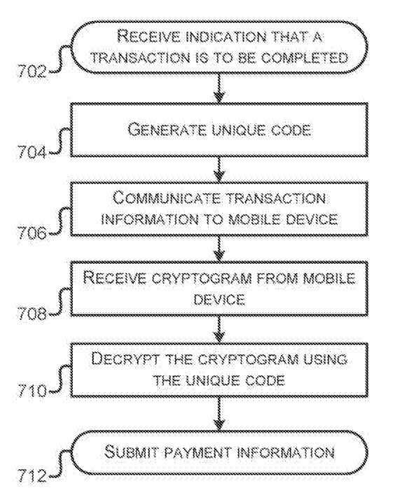

FIG. 7 depicts a process for conducting a secured transaction using multiple protocols in accordance with at least some embodiments. The process 700 is illustrated as a logical flow diagram, each operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be omitted or combined in any order and/or in parallel to implement this process and any other processes described herein.

Some or all of the process 700 (or any other processes described herein, or variations and/or combinations thereof) may be performed under the control of one or more computer systems configured with executable instructions and may be implemented as code (e.g., executable instructions, one or more computer programs or one or more applications). In accordance with at least one embodiment, the process 700 of FIG. 7 may be performed by at least the access device 106 depicted in FIG. 1 and FIG 3. The code may be stored on a computer-readable storage medium, for example, in the form of a computer program including a plurality of instructions executable by one or more processors. The computer-readable storage medium may be non-transitory.

Process 700 may begin at 702, when an access device receives an indication that a transaction is to be completed. In some embodiments, process 700 may begin when payment information is received. In some embodiments, the indication may include information related to the transaction to be completed. For example, the indication may include a transaction amount, information related to one or more items involved in the transaction, a method of payment to be used to complete the transaction, or any other suitable transaction information. The access device may, in response to receiving this indication, generate a unique code (e.g., an unpredictable number) at 704.

Upon generating a unique code, the access device may identify one or more communication protocols available to the access device. In some embodiments, an indication of one or more communication protocols may be included in the transaction information received by the access device. Upon identifying an appropriate communication protocol, the access device may communicate the transaction information (including the unique code) to the mobile device at 706. For example, the access device may receive an indication that the transaction information should be transmitted via a near field communication antenna. In some embodiments, the access device may transmit the transaction information to a mobile device via the NFC antenna upon identifying that a mobile device is within the vicinity of the NFC antenna. In some embodiments, the access device may be pre-configured to utilize a particular communication protocol. For example, the access device may be preprogrammed to generate and display a barcode on a display screen each time that a transaction is to be completed.

Upon communicating the transaction information to the mobile device, the access device may be configured to await a response from the mobile device via a separate communication protocol. The access device may receive a cryptogram generated by the mobile device at 708 via the separate communication protocol. In some embodiments, the cryptogram may be an encrypted payment account identifier. In some embodiments, the cryptogram may be a predetermined data that has been encrypted. In some embodiments, the provided unique code may act as an encryption key, with which the mobile device may generate the cryptogram. In some embodiments, the access device may decrypt the cryptogram using the unique code or a separate decryption key related to the unique code (e.g., a private key in a key pair) at 710. Upon decryption of the cryptogram, the access device may submit the payment account information to an acquirer computer to complete a transaction at 712. For example, the access device may attempt to utilize the decrypted information as payment information. In some embodiments, if the information has been improperly encrypted or decrypted, the payment information identified may be invalid and the transaction will not be authorized. This may serve to authenticate the mobile device.

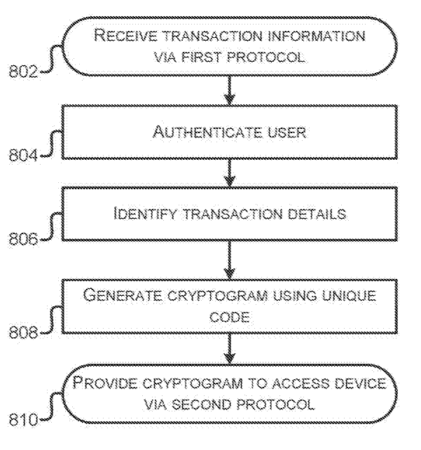

FIG. 8 depicts a process for receiving a transaction request via a first protocol and responding via a second protocol in accordance with at least some embodiments. Some or all of the process 800 may be performed under the control of one or more computer systems configured with executable instructions and may be implemented as code (e.g., executable instructions, one or more computer programs or one or more applications). In accordance with at least one embodiment, the process 800 of FIG. 8 may be performed by at least the mobile device 104 depicted in FIG. 1 and FIG. 2. The code may be stored on a computer-readable storage medium, for example, in the form of a computer program including a plurality of instructions executable by one or more processors. The computer-readable storage medium may be non-transitory.

Process 800 may begin at 802, when transaction information is received by a mobile device via a first communication protocol. In some embodiments, the mobile device may already be in communication with an access device via a second communication protocol. For example, a user of the mobile device may have executed a payment application on the mobile device, which had subsequently conveyed payment information to the access device. In this scenario, the transaction information may be received by the mobile device via the first communication protocol in response to providing the payment information.

In some embodiments, the mobile device, upon receiving transaction data, may attempt to authenticate a user of the mobile device at 804. For example, the mobile device (or an application executed on the mobile device) may require that a user enter a pin or password in order to proceed with the process 800. In some embodiments, the mobile device may authenticate the user prior to initiating the process. Additionally, it should be noted that this step may not be performed in some embodiments of the process 800.

In some embodiments, the mobile device may parse the transaction information to identify one or more particular transaction details at 806. For example, the mobile device may identify a unique code included in the transaction details. In another example, the mobile device may populate a number of variables with values identified from the transaction details The mobile device may utilize the identified unique code to generate a cryptogram at 808. For example, the unique code may be used as an encryption key, along with an encryption algorithm, to encrypt a portion of data. This encrypted portion of data may be a cryptogram. In some embodiments, the data to be encrypted may be a payment account identifier to be used in conducting the transaction. In some embodiments, the data to be encrypted may be a static or predetermined data (e.g., a code or text string stored in the mobile device). In some embodiments, the data to foe encrypted may be one or more values received in the transaction details.

Once the cryptogram has been generated by the mobile device, it may be provided to the access device at 810. In some embodiments, this may require that the cryptogram be formatted in a particular way or included in a formatted response. The particular format may be determined based on the transaction protocol to be used. For example, the mobile device may generate a response that includes the cryptogram that is suited to a barcode reader protocol. In this example, a text response may be generated to include the cryptogram. The text may then be embedded in a barcode and displayed on the screen of the mobile device. In some embodiments, the entire process 800 may be performed without user interaction and within a short period of time (e.g., within a fraction of a second). For example, it is envisioned that in embodiments in which the user has initiated the process 800 by displaying a barcode having payment information to an access device, the process will act to generate and display a second barcode having a cryptogram before the user moves the mobile device out of the barcode scanner's field of view. In some embodiments, the user may not even be aware that the barcode has been updated, or that the cryptogram has been provided to the access device.

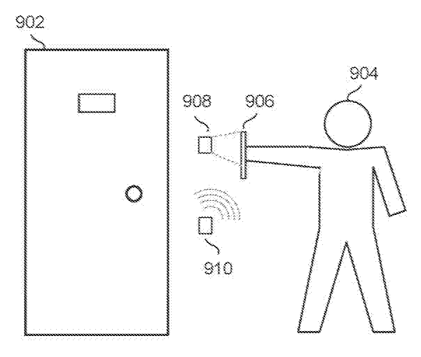

FIG. 9 depicts an illustrative example of an embodiment in which a mobile device may be used to gain access to a building in accordance with at least some embodiments. In FIG. 9, an access point 902 may be secured using an electronic locking device. In at least some embodiments, a user 904 may wish to gain entry to an area via the access point 902. The user 904 may be in possession of a mobile device 906. The mobile device 906 may have stored computer executable instructions that, when executed, cause the mobile device to display a barcode identification. For example, the mobile device may display a machine readable code embedded with information related to the user 904 and/or the mobile device 906.

In the illustrated example, the mobile device 906 may be presented to a barcode scanner 908 and/or a radio frequency identification transmitter 910. The barcode scanner 908 and radio frequency identification transmitter 910 may be communicatively coupled to a processor device configured to lock or unlock the access point 902. Upon presentation of the machine readable code to the barcode scanner 908, the processor device may cause the radio frequency identification transmitter 910 to transmit a unique code to the mobile device 906. Upon receiving the unique code, the mobile device may generate and display a second machine readable code, the second machine readable code embedded with a cryptogram generated from the unique code. The second machine readable code may then be scanned and translated by the barcode reader 908.

In some embodiments, when the mobile device 906 is positioned so that the barcode reader 908 may scan the first generated machine readable code, the mobile device may be configured to receive the unique code and generate the second machine readable code within a short period of time. For example, the mobile device may be configured to generate and display the second machine readable code before the user has repositioned the mobile device 906. This technique may be used to ensure that the mobile device has the proper computer executable instructions installed for cryptogram generation.

The various participants and elements described herein with reference to FIGS. 1-9 may operate one or more computer apparatus to facilitate the functions described herein. Any of the elements in FIGS. 1-9 may use any suitable number of subsystems to facilitate the functions described herein.

The subsystem can be interconnected via a system bus. Additional subsystems such as a printer, keyboard, fixed disk (or other memory comprising computer readable media), monitor, which is coupled to a display adapter, and others are shown. Peripherals and input/output (I/O) devices, which couple to I/O controller (which can be a processor or other suitable controller), can be connected to the computer system by any number of means known in the art such as a serial port. For instance, serial port or an external interface can be used to connect computer apparatus to a wide area network such as the Internet, a mouse input device, or a scanner. The interconnection via system bus allows a central processor to communicate with each subsystem and to control the execution of instructions from a system memory or fixed disk, as well as the exchange of information between subsystems. System memory 908 and/or fixed disk may embody a computer readable medium (e.g., a non-transitory computer readable medium).

Further, while the present invention has beers described using a particular combination of hardware and software in the form of control logic and programming code and instructions, if should be recognized that other combinations of hardware and software are also within the scope of the present invention. The present invention may be implemented only in hardware, or only in software, or using combinations thereof.

Any of the software components or functions described in this application may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

A recitation of “a”, “an” or “the” is intended to mean “one or more” unless specifically indicated to the contrary.

All patents, patent applications, publications, and descriptions mentioned above are herein incorporated by reference in their entirety for all purposes. None is admitted to be prior art.

What is claimed is:

1. A computer-implemented method comprising:
providing, to a mobile device via a first transaction protocol, information related to the transaction, the information related to a transaction including a unique code;
receiving, from the mobile device via a second transaction protocol different from the first transaction protocol, a response;
determining, based at least in part on the response, that the mobile device received the unique code; and
in response to determining that the mobile device received the unique code, completing the transaction using information included in the response.

2. The method of claim 1, wherein the unique code is an unpredictable number.

3. The method of claim 1, wherein the first transaction protocol comprises one of a near field communication protocol and a machine readable code.

4. The method of claim 3, wherein the second transaction protocol comprises the other of the near field communication protocol and the machine readable code.

5. The method of claim 1, wherein the response message is encrypted using the unique code.

6. The method of claim 1, wherein determining that the mobile device received the unique code comprises decrypting the response message.

7. The method of claim 1, wherein the indication that a transaction is to be completed is received from the mobile device via the second transaction protocol.

8. A mobile device comprising:
a processor; and
a memory including instructions that, when executed with the processor, cause the electronic device to, at least:
receive, from an access device via a first protocol, information related to a transaction to be completed;
identify, from the received information, a unique code related to the transaction;
generate, using the unique code, a cryptogram; and
provide, via a second protocol, the cryptogram to the access device.

9. The method of claim 7, wherein the unique code is a public key of an asymmetric keypair, and the cryptogram is generated by encrypting data using the unique code.

10. The method of claim 7, wherein the unique code is a symmetric key, and the cryptogram is generated by encrypting data using the unique code.

11. The method of claim 7, wherein the instructions further cause the electronic device to at least determine an account identifier to be used in completing the transaction, the account identifier provided to the access device via the second protocol.

12. The method of claim 11, wherein the cryptogram is generated from the account identifier.

13. The method of claim 7, wherein the second protocol is a barcode reader and the cryptogram is provided to the access device in a barcode.

14. A computer-implemented method comprising:
receiving, by a mobile device, transaction data for a transaction in accordance with a second transaction protocol, the transaction data being received from an access device;
generating, by the mobile device, a response using the received transaction data; and
transmitting, by the mobile device, the generated response in accordance with a first transaction protocol.

15. The method of claim 14, wherein the transaction data received from the access device includes an unpredictable number.

18. The method of claim 15, wherein generating the response includes generating a cryptogram using the unpredictable number.

17. The method of claim 18, wherein generating the response further includes encoding the cryptogram in a machine readable code.

18. The method of claim 17, wherein the machine readable code is a two dimensional barcode.

19. The method of claim 14, wherein after the transaction is initiated, the response is transmitted without user interaction.

20. The method of claim 14, further comprising initiating, by the mobile device, the transaction in accordance with the first transaction protocol, the first transaction protocol being associated with contactless unidirectional communication.
